(19) United States
(12) Patent Application Publication
(10) Pub. No.: US 2025/0145522 A1
(43) Pub. Date: May 8, 2025

(54) AUTOMOTIVE GLAZING WITH FUNCTIONAL COATING ON TEXTURED GLASS

(71) Applicant: AGP WORLDWIDE OPERATIONS GMBH, Zug (CH)

(72) Inventors: Alexey KRASNOV, Canton, MI (US); Kevin CANO CAMPOBLANCO, Lima (PE); Stefan GOSSEN, Aachen (DE); Eduardo TEMOCHE SOLANO, Lima (PE)

(21) Appl. No.: 18/502,489

(22) Filed: Nov. 6, 2023

(51) Int. Cl. C03C 17/36; B32B 1/00; B32B 17/10; H04N 9/31

(52) U.S. Cl. CPC C03C 17/366; B32B 1/00; B32B 17/10036; B32B 17/10146; B32B 17/10229; B32B 17/10449; B32B 17/10467; B32B 17/10651; B32B 17/10761; C03C 17/361; C03C 17/3615; C03C 17/3618; C03C 17/3626; C03C 17/3649; C03C 17/3681; H04N 9/3141; B32B 2307/414; B32B 2307/538; B32B 2605/00; C03C 2217/73

(57) ABSTRACT

The present invention discloses a laminated glazing for a vehicle having thermal insulation properties. To solve antireflection issues, the glazing is comprised of a second glass layer having texturing features onto its external surface and a low-emissivity coating disposed onto said texturing features. The texture of the glass and the design of the low-E coating are tuned in such a way as to ensure a good adhesion of the coating during high-temperature bending process and, at the same time, to enable its low level of emissivity. The glazing may comprise a color and/or solar control coating onto the internal surface of the first glass layer. The glazing may also comprise photovoltaic cells and/or visible light transmission elements. In another embodiment still, the low-E coating onto the texturing features is tuned to serve as an image projection element.

### FIELD OF THE INVENTION

The present invention falls in the field of glazing and, more particularly, it relates to low-emissivity coatings, preferably automotive glazing, such as automotive roof, with low-emissivity capabilities and image projection.

### BACKGROUND

Glass sunroofs have become especially popular among the costumers due to the unique ability of glass to both separate the vehicle's interior from the outside while still providing visual connectivity to the surrounding.

For many drivers, it would be desirable to have a glass sunroof with a new and improved exterior and interior aesthetics which would bring a feel of comforting visual seclusion and privacy, a more personalized look, and the ability to add new functionalities. In this case, new sunroof options may either allow ample natural light to enter the cabin in a diffuse mode through translucent glass or visually separate the vehicle interior from the

outside world and, instead, create a more appealing aesthetics combined with artificial visual experience, e.g., by projecting on the textured inner surface various static images or dynamic scenes. The former option would be ideal, e.g., in climates with excessive amount of sunlight, while the latter for the geographical areas having too many overcast days.

The increase in the glazing area also increases the solar load on the vehicle if conventional glazing is used. This may require a larger air conditioning unit which translates into reduction of fuel efficiency. However, it is possible to reduce the solar load through the use of solar control glazing. This is especially important for electric vehicles where the improvement results into an increase in the range of the vehicle which is a key consumer concern.

Solar protection can be provided to the glazing by several methods, one of them being by the use of low-emissivity (low-E) coatings as has been widely demonstrated in the prior-art. However, with the increased size of glazing and with the use of low-E coatings, reflection becomes one of the main problems in automotive applications. Car manufacturers prefer the outlines of the modules but not the glare to be visible to the driver and the passengers. It may cause distraction to the driver which poses a risk to the safety of the vehicle occupants.

Moreover, there is a hard push from the customers to obtain a means for transportation more energy sustainable. The result is that the automotive industry has been working on integrating photovoltaic (PV) devices onto the vehicles. Only a few have attempted to embed photovoltaic devices into the glazing, but there are still many challenges to be overcome so to open this solution to the market. One of the problems associated with PV modules embedded into laminated roofs is that again the modules cause parasitic reflection distractively visible to the vehicle occupants.

It would be desirable to provide a solution to the aforementioned problems.

### DESCRIPTION OF THE INVENTION

The invention discloses laminated glazing with thermal insulation properties. The glazing has a low-emissivity (low-E) coating disposed on the external surface of the second glass layer on top of texturing features. The texturing of the glass and the design of the low-E coating are tuned in such a way as to ensure a good adhesion of the coating during high-temperature bending process and, at the same time, to enable its low level of emissivity (translated into thermal insulation). In some example embodiments, the low-E coating on textured glass is applied in an automotive roof. In another embodiment, the low-E coating is dark. In yet another embodiment, the coating is colored.

In a first inventive aspect, the present invention provides a laminated glazing with low-emissivity capabilities for a vehicle comprising at least two glass layers, a first glass layer and a second glass layer that are bonded to one another by at least one bonding interlayer. Each one of the first and second glass layers have interior surfaces oriented towards the inside of the laminate and exterior surfaces oriented to the outside of the laminate. The exterior surface of the second glass layer comprises at least one area having texturing features (also referred to textured glass or glass with texture). A low-emissivity coating is disposed onto at least a portion of the at least one area with the texturing features. The low emissivity coating adds thermal insulation to the glazing and is able to achieve emissivity of below 0.3, and preferably below 0.2.

In a second inventive aspect, the invention provides a system comprising laminated glazing with low-emissivity capabilities for a vehicle and at least one image projector. The at least one image projector is configured to project an image onto the at least one area with the texturing features of the second glass layer.

### DESCRIPTION OF THE DRAWINGS

These and other features and advantages of the invention will be seen more clearly from the following detailed description of a preferred embodiment provided only by way of illustrative and non-limiting example in reference to the attached drawings.

FIG. 1A This figure shows a laminated glazing having texturing features and low-emissivity coating.

FIG. 1B This figure shows a particular embodiment of the present invention.

FIG. 1C This figure shows a particular embodiment of the present invention.

FIG. 2A This figure shows a detail of the low emissivity coating of the invention disposed onto the second glass layer.

FIG. 2B This figure shows a particular embodiment of the present invention.

FIG. 3 This figure shows Secondary Electron Spectroscopy of the at least one area of the glass with texturing features.

FIG. 4A This figure shows a table with the composition (columns) and thickness in nm (rows) of each layer of nine different low-emissivity coating designs (A-I) used to exemplify the invention.

FIG. 4B This figure shows a table with the composition (columns) and thickness in nm (rows) of each layer of nine different color control coating designs (A-I) disposed onto at least a portion of the internal surface of the first glass layer used to exemplify the invention according to one of the embodiments.

FIG. 5 This figure shows a system comprising the glazing of the invention and at least one image projector according to the second aspect of the invention.

### DETAILED DESCRIPTION OF THE INVENTION

As will be appreciated by one skilled in the art, aspects of the present invention may be embodied as a product or method.

The present invention provides a laminated glazing (100, 200, 300) with low-emissivity capabilities for a vehicle comprising:
at least two glass layers (2) comprising:
   a first glass layer (201) having an exterior surface (101) oriented towards the outside of the laminated glazing and an interior surface (102) oriented towards the inside of the laminated glazing,
   a second glass layer (202) having an interior surface (103) oriented towards the inside of the laminated glazing, and an exterior surface (104) oriented towards the outside of the laminated glazing, wherein the second glass layer comprises at least one area on the exterior surface (104) having texturing features (5),
at least one bonding interlayer (4) disposed between the interior surface (102, 103) of the first glass layer and/or the second glass layer; and
a low-emissivity coating (3) disposed onto at least one portion of the at least one area with texturing features (5) of the external surface (104) of the second glass layer, and characterized in that the emissivity of the coated glazing is below 0.3, preferably below 0.2.

In the context of this disclosure, a portion means partial or complete region. In the case of the low-emissivity coating, at least a portion of the coating is disposed on top of said at least one area with texturing features. This means that the coating region may cover similar, smaller or a larger area of the at least one area with the texturing features.

Low-emissivity coatings, abbreviated ‘low-E’, are commonly known in the state of the art. Low-E typically implies a highly electrically conductive coating on the inner surface of the glass roof serving to prevent the absorption and consequent re-radiation of the heat energy from the sun on hot days into the passenger compartment. The more energy is transferred, the more fuel must be spent to keep the air conditioner working to provide passengers' comfort. Besides, an automotive roof without a low-E coating can absorb sufficient solar radiation to get very hot on touch.

In winter, the situation is the opposite. Automotive roofs with a higher emissivity lose more heat energy to the cold environment (outside the vehicle), thus putting more load on the vehicle's heater to keep passengers warm.

Emissivity (ε) is a measure of how much thermal radiation a body, such as an automotive glass roof, emits to its environment. This characteristic is unitless and ranges between 0 and 1. It is directly proportionate to sheet resistance of a low-E coating. The lower the sheet resistance, the lower the emissivity of the roof can be achieved. Emissivity with values less than 0.3 are preferred for automotive roofs.

In a typical manufacturing cycle, a low-E coating is deposited, by means of Magnetron Sputtered Vacuum Deposition (MSVD), and more specifically, by reactive sputtering. However other means may also be used without departing from the spirit of the invention.

In an embodiment, the deposition of the layers of the coating is made by electron-beam deposition, ion-beam deposition, or chemical-vapor deposition (CVD), such as plasma-enhanced CVD.

The low-emissivity coating of the invention comprises at least one layer based on transparent conductive oxide (TCO). Traditional low-E coatings used in automotive roofs use a layer of indium-tin-oxide (ITO), which is a TCO with a sufficiently low sheet resistance to enable a low emissivity and, at the same time, be sufficiently transparent to provide daylight coming through the roof into the vehicle interior. The ITO is sandwiched between at least two dielectric layers serving as a blocker against sodium diffusion from the glass and as top scratch protection layer.

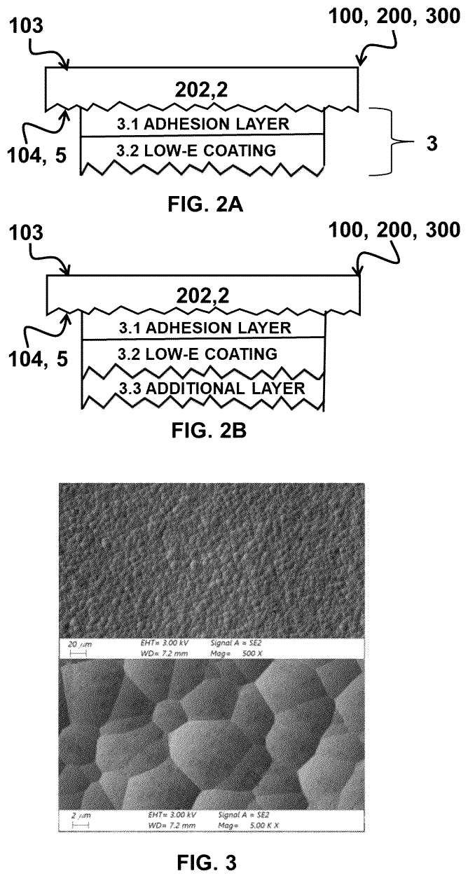

In one embodiment of the invention, at least one additional layer (3.3) can be deposited over the low-E coating, such as an anti-reflective (AR) layer, or an anti-fingerprint (AF) layer or a combination thereof. This is illustrated in FIG. 2B. Alternatively, additional layer or layers, such as high index of refraction NbOx or TiOx paired with low index of refraction SiOx or SiOxNy, may be embedded in the low-E coating and provide it with anti-reflection properties.

In another embodiment of the invention, the glazing further comprises a functional element disposed in between the first and second glass layers selected from the following: photovoltaic device, and a variable light transmission element, or a combination thereof.

Photovoltaic (PV) device is a very broad term. Any device converting visible or not visible light (including the solar light spectrum) into electricity is a photovoltaic device. Therefore, photovoltaic devices include, but are not limited to crystalline, poly-crystalline, and amorphous Si thin-films, including a-Si, CdTe, and CIGS; organic photovoltaic (both small-molecule and polymer-based); III-V based; as well as all others which are yet invented.

Laminates that incorporate these variable light transmittance elements are sometimes referred to as “smart” glass or switchable glass. Variable light transmission (VLT) elements are used to control the level of light transmission through the laminate. There are many VLT technologies available: electrochromic, photochromic, thermochromic and electric field sensitive films which are designed to be incorporated into laminated glass. Of interest are suspended particle device (SPD) films and polymer dispensed liquid crystal (PDLC) films which can quickly change their light transmittance in response to an electrical field. Liquid crystal (LC) layers are also VLT layers used in vehicles.

In one embodiment of the invention, the laminated glazing further comprises a variable light transmission layer that occupies less than 70% of the total area of the glazing.

The use of texture may become especially important for glass sunroofs with laminated power-generating photovoltaic solar cells. In this case, there is a strong and undesirable mirror-like interior reflection from the back of the cells, which must be dealt with. One of the solutions could be the use of opaque black PVB between the solar cells and the second glass. This approach, however, does not eliminate the reflection from the exterior glass surface of the second glass layer. It also completely obscures the view of the solar cells, which some car manufacturers prefer to be visible to the vehicle occupants. The mirror-like reflection may be eliminated by providing texturing features onto the exterior surface of the second glass layer. Texturing features may be anti-glare agents, and advantageously the glazing surface facing the interior of the vehicle cabin gains a pleasant matte appearance. Another benefit of having a roof with the surface facing the interior of the vehicle with texturing features is in suppressing the disturbing interior color disbalance caused by the reflected light generated by the cabin interior lighting and displays in the dashboard.

Texturing features are defined in the context of the invention as a plurality of protrusions (or features) produced onto at least one area of the surface of the glass layer that are randomly distributed and create the roughness of the surface area.

According to a specific embodiment of the present invention, the surface root-mean-square (rms) roughness Ra of the at least one area with texturing features may be in the range from 0.01 μm to 1.0 μm, preferably from 0.02 μm to 0.4 μm, as measured by an Atomic Force Microscopy (AFM). In a most preferred embodiment, Ra is in the range from 0.05 μm to 0.3 μm.

The main anticipated problem when combining low-E coating with textured glass is that the emissivity increases, i.e., the thermal insulation effect gets worse. However, the invention proposes how to obtain a glazing having a low-E coating within the expected range for vehicle application and at the same time control reflection by the use of texturing features.

In one embodiment of the invention the texturing features on the second glass layer were found to provide optimal performance when sized from 1 to 20 μm, and preferably from 2 to 10 μm. The size of the feature is the largest measurable distance within the shape. Measurement is performed onto a micrograph obtained by Secondary Electron Microscopy (SEM). In one particular embodiment of the invention, the texturing features were in the range from 2 to 10 μm as shown in FIG. 3.

In one embodiment, the at least one area with texturing features of the second glass layer has a haze that ranges from 5 to 99% and the area without the texturing features has a haze of no more than 5%. Preferably, the at least one area with texturing features of the second glass layer has a haze that ranges from 20 to 50%, and more preferably the haze ranges from 30 to 40%. In comparison larger feature sizes were found to lead to an increased emissivity. The reason behind this is that the heat waves (mid-infrared radiation with wavelength from 10 to 50 μm) start to interfere more with the textured surface. This results in more heat absorbed by the features and then re-radiated into the opposite side of the glazing, from where the heat was generated.

Haze is measured as the percentage of incident light scattered by more than 2.5 degrees through a glass sample (in this case, from the external surface of the second glass layer towards the interior surface thereof) and it is expressed in percentage (%), Haze measurement is detailed in Krasnov, A. (2010) Light scattering by textured transparent electrodes for thin-film silicon solar cells vol. 94, no. 10, pp. 1648-1657, Solar Energy Materials and Solar Cells, https://doi.org/10.1016/j.solmat.2010.05.022. In the present disclosure haze was measured using a haze meter according to the ASTM D1003-21 standard with an illumination source C/10°.

Texturing features can be achieved onto the glass by any of the following or a combination: chemical treatment, sandblasting, laser patterning and embossed roller patterning. One example of providing texturing features by chemical treatment is to perform etching onto one or both surfaces of the glass with buffered hydrofluoric acid. Once the glass layer is comprised of texturing features it becomes a textured glass.

Texturing features 5 can be provided onto at least one area of the glass surface, such as onto one area, or multiple areas. May methods can be used to obtain isolated areas with texturing features. One of them could be by the use of masking. Texturing features can be also provided onto one entire surface of the glass layer or onto both entire surfaces of the glass layer.

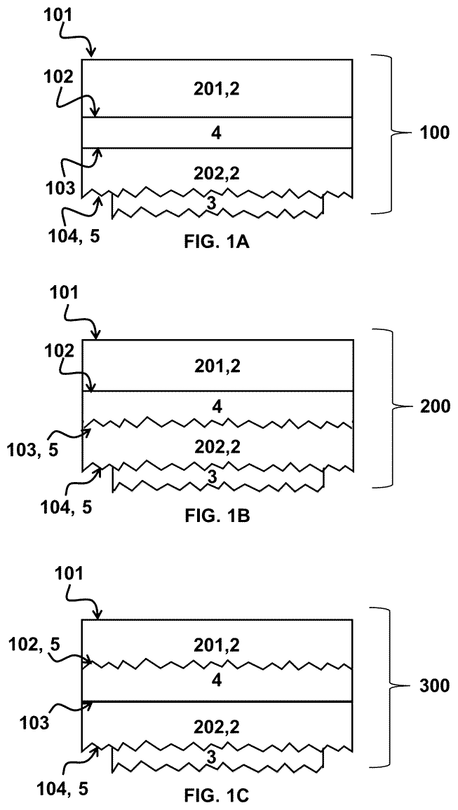

In one embodiment of the invention, single-sided textured glass is used. This is illustrated in FIG. 1A by glazing 100 and FIG. 1C by glazing 300. In another embodiment of the invention double-sided textured glass may be used and is cheaper. This is illustrated in FIG. 1B, by glazing 200. It is also possible to use a double-sided textured glass as the second glass layer and a single-sided textured glass as the first glass layer without departing of the spirit of the invention (not illustrated).

Yet in one embodiment of the invention, at least one area with texturing features is smaller than the total area of the external surface of the second glass layer.

There is another potential problem associated with combining low-emissivity coating with textured glass and that is adhesion. Low-E coating adhesion may decrease when the coating is deposited directly onto the texturing features. In a flat sheet of glass this effect might not become a problem. However, when the glass sheet undergoes thermal bending, adhesion may be compromised. Therefore, the low-E coating 3 of the present disclosure was designed in such a way as to provide a good adhesion to the textured glass when it is curved. The low-emissivity coating 3 disposed on the at least one area with texturing features of the external surface of the second glass layer, comprises an adhesion layer 3.1 in contact with said texturing features.

In one aspect of the invention the adhesion layer 3.1 maybe the first layer—adjacent to the textured external surface of the low-E coating 3. A detail of this embodiment is shown in FIG. 2A. For simplification reasons, the first glass layer is not shown in the figure. The adhesion layer 3.1 is an ultra-thin layer, having a thickness of several nm, such as below 10 nm, and preferably several nm, such as in the range from 1 to 3 nm. In one embodiment the chemical composition of the adhesion layer may comprise at least one of the following: NiCr, NiCrOx, CrOx, and any combination thereof. When magnetron-sputtered, the adhesion layer is conformal to the textured surface and creates a strong bond with it. It also adheres strongly to the low-E coating 3.2. Small thickness of the layer allows its high bendability. As a result, the adhesion of the low-E coating to the textured glass is not compromised when the glass is bent at high temperature.

In another embodiment of the invention, the total solar transmittance of the glazing may be no more than 60%. In a preferred embodiment the total solar transmittance should be in the range from 5% to 60%, more preferably in the range from 10% to 40% and even more preferably from 15% to 25%, including the end values. In this case the glazing of the invention may be a roof for a vehicle. A few examples of roofs for vehicle are sunroof, moonroof or panoramic roof.

The following terminology is used throughout the whole document to describe features of the invention.

The term “layer”, as used in this context, shall include the common definition of the word, i.e.: a sheet, quantity, or thickness, of material, typically of some homogeneous substance.

As has already been mentioned, the term “emissivity” or its acronym “E” is a measure of how much thermal radiation a material's surface, such as an automotive glass roof, emits to its environment. Thermal radiation is electromagnetic radiation that may include both visible radiation (light) and infrared radiation, which is not visible to human eyes. The thermal radiation from very hot objects is easily visible to the eye. Quantitatively, emissivity is the ratio of the thermal radiation from a surface to the radiation from an ideal black surface at the same temperature as given by the Stefan-Boltzmann law. This characteristic is unitless and ranges between 0 and 1. It is proportionate to sheet resistance of a low-E coating. The lower the sheet resistance, the lower the emissivity of the roof can be achieved. A low-E for automotive application should be understood as below or equal to 0.3; and preferably below or equal to 0.2.

Thickness values, unless indicated to the contrary, are geometric thickness values.

The term “glass substrate” or “glass pane” should be understood as a sheet, quantity, or thickness of material, typically of some homogeneous substance. The “glass substrate or pane” may comprise one or more layers. The glass substrate can be, for example, clear, tinted or colored glass. The glass substrate can be any one of the following dimensions: length, width, shape, or thickness.

The terms “glass pane” and “laminated glass pane” refer respectively to a glazing having one glass layer and to a laminated glazing having at least two glass layers.

“Laminates”, in general, are products comprised of multiple sheets of thin, relative to their length and width, material, with each thin sheet having two oppositely disposed major faces and typically of a relatively uniform thickness, which are permanently bonded to each other across at least one major face of each sheet.

The term “stack” refers to the arrangement in a pile manner of a plurality of layers. When describing the coating stack, the convention of numbering the coating layers in the order of deposition upon the glass substrate should be used.

Also, throughout this document, when two layers of the coating are described, the one which is the closest to the substrate shall be referred to the bottom layer or the first layer and the subsequent layers shall be referred to second layer, and so on. Likewise, the top layer is the very last layer applied to the coating stack.

As for one individual layer of the coating, the top of an individual layer has to be understood as the side of the layer furthest from the substrate while the bottom has to be understood as the side of the layer which is either in contact with the substrate or oriented towards the substrate in case this layer is not the first layer of the coating stack.

With respect to a second layer located on a first layer in the coating, the term “on” should be understood as including both the option of the first and second layers being in direct contact (i.e., physical contact) and the option of having one or more additional layers located between the first layer and the second layer.

The term “glass” can be applied to many organic and inorganic materials, including many that are not transparent. From a scientific standpoint, “glass” is defined as a state of matter comprising a non-crystalline amorphous solid that lacks the long-range ordered molecular structure of true solids. Glasses have the mechanical rigidity of crystals with the random structure of liquids.

The term “glazing” should be understood as a product comprised of at least one layer of a transparent material, preferably glass, which serves to provide for the transmission of light and/or to provide for viewing of the side opposite to the viewer and which is mounted in an opening in a building, vehicle, wall or roof or other framing member or enclosure.

When a range is of values is provided in the application, it should be understood that the two limiting values of the range are also included. For example, if a range of 20 to 100 nm is provided, the values 20 and 100 nm are also included within the range.

When describing the coating stack, the convention of numbering the coating layers in the order of deposition upon the glass substrate should be used.

The at least one glass layer can be a single glass layer or a multiple glass layers.

In an embodiment, the type of glass for any of the first and/or second glass layers is selected from clear soda-lime glass, tinted soda-lime glass, aluminosilicate glass, borosilicate glass.

Preferably, the thickness of the at least one glass layer may vary widely and thus be ideally adapted to the requirements of the individual cases. In an embodiment, the thickness of the at least one glass layer of the glazing of the invention is lower than 5.0 mm, preferably comprised between 0.3 mm and 5.0 mm, such as between 0.5 mm and 4.0 mm or between 1.0 mm and 3.0 mm. Possible examples of thicknesses of the at least one glass layer are about 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm or 3.0 mm. More preferably, the glass layer is about 2.1 mm thick soda-lime glass layer, including ultra-clear, clear or green soda-lime.

The at least one bonding layer is selected from a clear thermoset plastic, also called polyvinyl butyral (PVB), ethylene vinyl acetate (EVA), and thermoplastic polyurethane (TPU).

Additional embodiments of the present invention may include a plastic interlayer made of tinted PVB. Tinted PVB interlayers may have different levels of light transmission and can be of different thicknesses. Preferably, the thickness of the plastic bonding layer, clear or tinted is comprised between 0.3 mm and 2.0 mm, such as between 0.5 mm and 1.0 mm, e.g., about 0.5 mm, 0.6 mm, 0.7 mm, 0.8 mm, 0.9 mm or 1.0 mm. Particular thicknesses for the plastic bonding layer, e.g., a-tinted-PVB interlayer, are for instance 0.38 mm, 0.631 mm and 0.76 mm.

In another embodiment, the laminated glazing of the invention further comprises an infrared blocking layer positioned between the first and second glass layers and selected from the group of a film and/or a coating.

In one particular embodiment, the PVB plastic interlayer is comprised of particles that absorb partially the infrared light of the sun. Preferably, the interlayer may have solar attenuating properties.

The term “vehicle” in the present invention includes, but is not limited to, road vehicles (e.g. cars, busses, trucks, agricultural and construction vehicles, cabin motorbikes), railway vehicles (e.g. locomotives, coaches), aircraft (e.g. airplanes, helicopters), boats, ships and the like. For instance, the vehicle may be a road vehicle and more particularly a car.

In one embodiment, the glazing of the invention has a second glass layer further comprising at least one area with texturing features onto the interior surface. This embodiment is illustrated in FIG. 1B.

In another embodiment, the glazing of the invention has a first glass layer further comprising at least one area having texturing features onto its interior surface. This embodiment is illustrated in FIG. 1C. Additionally, a color and/or solar control coating may be disposed onto the at least a portion of said at least one area with texturing features of the first glass layer (not shown in the figure). A color control coating is mostly desired by the OEMs and customers to provide a customized exterior aesthetics to the glazing. However, traditional specular color coating films in the market have a strong angular dependence of scattered light. Therefore, the use of a color control coating on top of texturing features substantially reduces the angular dependency of color as well as the intensity of the reflected exterior light.

In the present disclosure color is measured and reported following CIELAB color system. CIELAB is one of the many color spaces and is normally used in automotive and architectural industries. The advantage of the CIELAB color system is that color shifts on the CIELAB diagram are perceived proportionally by the human eye. The CIELAB L*, a*, b* color space mathematically describes all perceivable colors in three dimensions: L* for perceptual lightness, a* for green-red, and b* for blue-yellow. One of the most important attributes of the CIELAB model is device independence, which means that the colors are defined independent of their nature of creation or the device they are displayed on.

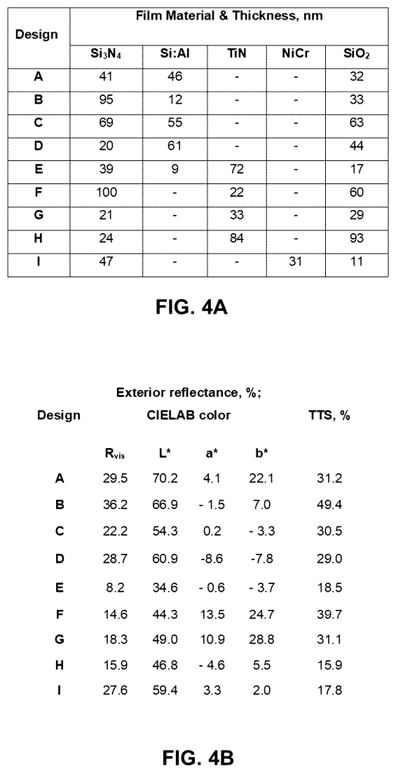

Color control coatings can be based on any or a combination of the following materials: silicon nitride based, silicon oxide based, Si:Al, TiN and NiCr. FIG. 4A shows examples of nine different designs of coatings (A-I). Each row shows the chemical composition of the coating layers starting from left to right and its physical thickness measured in nm.

Besides enabling a wide range of reflected colors, some designs of color coatings shown in FIG. 4A may serve the purpose of reducing the thermal impact of total solar irradiance on the cabin, in terms of both directly transmitted solar energy in the near-infrared and the heat energy absorbed by the glazing and then re-radiated in the mid-infrared range of the electromagnetic spectrum. The percentage of this combined transferred radiation is referred to as Transmission of Total Solar energy (TTS). To be effective in reducing the TTS, the coating must possess sufficiently high electrical conductivity. Mainstream laminated roof for vehicle designs use silver-inclusive solar coatings, such as double- and triple-silver thin-film stacks which offer high Visible Light Transmission (Tvis) and low TTS values. These ultra-thin silver-based coatings with each silver layer ranging from 8 to 20 nm are, however, way too delicate for the application on textured surfaces on which they lose their solar performance. Using coatings based on thicker and more durable electrically conductive materials instead of silver could be advantageous in providing sturdier solar control designs as well as lowering the cost. Some color coatings, as shown in FIG. 4B, result in a sufficiently low TTS to compete with silver-based coatings in solar performance for low Tvis glazing, and more specifically in roofs for vehicles. For those color coatings, which do not enable sufficiently low TTS values, additional solar control measures, such as infrared reflective layers laminated between the at least two layers of glass can be applied. More advanced coatings with a combination of conductive thin films may also be developed.

As can be seen from FIG. 4B, a broad gamut of example exterior colors is achievable using the color coating designs summarized in FIG. 4A. FIG. 4B also presents the TTS values of the complete laminated glazing comprising the color control coating deposited onto the texturing features of the first glass layer interior surface and the low-E coating deposited onto the texturing features of the second glass layer exterior surface.

In a second aspect of the invention, the glazing of the invention is provided with image projection capabilities. In this case a system is formed by the laminated glazing of the present invention 100, 200, 300 and at least one projector 10.

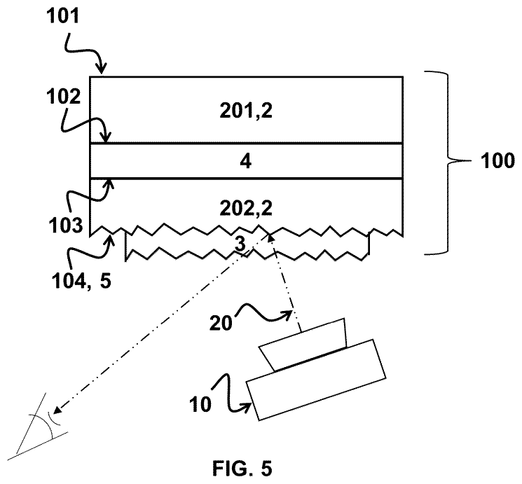

The system is characterized in that said the at least one projector 10 is configured to project an image 20 onto the at least one area with texturing features of the second glass layer. FIG. 5 illustrates one embodiment of the invention comprising the system mentioned above.

Combining a low-E coating with a textured glass substrate is inventive by creating a reflective surface with thermal insulation properties for front projection, such as in automotive roofs. In this case, the low-E coating, being conformal to the textured glass surface, assumes the texture of the surface. This results in a significant suppression of any specular component of the reflected image, which increases with the increasing angle of incidence for a typical low-E coating. The texture of the glass/low-E system on the exterior surface of the second glass layer, therefore, is ideal for both ensuring thermal insulation and quality of the image projected at any angle of incidence.

In the case of texturing features onto the first glass layer as well as of on the second glass layer, a tinted PVB or other medium may be used so as for the texturing features on the internal surface of the first glass layer do not interfere with the image projection onto the external surface of the second glass layer.

The following are examples of the realization of the invention.

### EXAMPLES

Example one demonstrates a glass layer having high visible light transmittance and low reflection. A single-sided textured glass was used. On top of the texturing features a low emissivity coating was deposited in the following order:

NiCr (1.5 nm)/SiOxNy (12.0 nm)/ITO (105.0 nm)/SiOx (108.0 nm).

Each layer indicated is separated by a slash symbol. The number in parenthesis is the physical thickness of the individual layer measured in nm. The light transmittance obtained was TL=88.0%, and the reflectance was RL=4.2%.

Optical properties in the visible and solar ranges, including Light transmission (TL) and Light reflectance (RL), of textured and nontextured samples were characterized with a Lambda 1050 UV/VIS/NIR Perkin Elmer spectrophotometer and evaluated according the ISO9050 specification. The tool was equipped with a Total Absolute Measurement System (TAMS) for the measurement of specular angular distribution of reflected light and a 150 mm integrated sphere which enabled the measurement of total amount of transmitted and reflected light, including its both specular and diffuse.

Example two demonstrates a dark low-E coating, having low light transmittance. It is similar to example one except that the low-emissivity coating has the following configuration:

2.1 mm SLG/NiCrOx (1.5 nm)/SiOxNy (16.4 nm)/NiCr (3.7 nm)/ITO (42.2 nm)/NiCr (9.7 nm)/ITO (54.3 nm)/NiCr (4.7 nm)/SiOx (93.1 nm).

This example provides a glazing coated with low-E with dark appearance. The light transmittance obtained was TL=10.1%, and the reflectance was RL=2.4%

Example three is similar to example one, except that it demonstrates a coated glazing with moderate light transmittance. The low-emissivity coating has the following configuration:

2.1 mm SLG/NiCr (1.5 mm)/SiOxNy (16.4 nm)/NiCr (2.0 nm)/ITO (42.2 nm)/NiCr (7.4 nm)/ITO (54.3 nm)/NiCr (4.7 nm)/SiOx (93.3 nm)

The light transmittance obtained was TL=17.3%, and the reflectance was RL=3.0%

Example four is similar to example one except that the low-emissivity coating has the following configuration:

2.1 mm SLG/NiCr (1.5 mm)/SiOxNy (20.3 nm)/ITO (33.9 nm)/ZnSnOx (11.5 nm)/ITO (61.9 nm)/NiCr (9.0 nm)/ZnSnOx (50.1 nm)/NiCr (4.5 nm)/SiOx (91.4 nm)

The light transmittance obtained was TL=17.4%, and the reflectance was RL=2.8%.

Example five is similar to example one except that the low-emissivity coating has the following configuration:

2.1 mm SLG/NiCr (1.5 mm)/SiOxNy (20.3 nm)/NiCr (3.7 nm)/ITO (91.7 nm)/NiCr (7.1 nm)/ZnSnOx (60.7 nm)/NiCr (3.5 nm)/SiOx (81.3 nm)

The light transmittance obtained was TL=18.2%, and RL=0.7%.

Example six is a laminated glazing having a second glass similar to the glass of example one and a first glass having a color coating deposited onto the interior surface of the first glass layer comprising of texturing features or not. FIG. 4A shows nine different color coatings (A, B, C, D, E, F, G, H, and I) and their respective sequences of layer composition (columns) and thickness in nm (rows) for each coating. The light transmittance and reflectance results are shown in FIG. 4B. The color coordinates (a*, b* and L) are presented in the CIELAB color space.

What is claimed is:

1. A laminated glazing for a vehicle having low-emissivity capabilities, the glazing comprising:
at least two glass layers comprising:
a first glass layer having an exterior surface oriented towards the outside of the laminated glazing and an interior surface oriented towards the inside of the laminated glazing,
a second glass layer having an interior surface oriented towards the inside of the laminated glazing, and an exterior surface oriented towards the outside of the laminated glazing, wherein the second glass layer comprises at least one area on the exterior surface having texturing features,
at least one bonding interlayer, being disposed between the interior surface of the first glass layer and/or the second glass layer; and
a low-emissivity coating disposed onto at least one portion of the at least one area with texturing features on the external surface of the second glass layer and characterized in that the emissivity of the coated glazing is below 0.3, preferably below 0.2.

2. The glazing according to claim 1, wherein the glazing is a curved laminated glazing.

3. The glazing according to claim 1, wherein the glazing is a curved laminated glazing and further comprises an adhesion layer in contact with said texturing features.

4. The glazing according to claim 3, wherein the adhesion layer has a chemical composition comprising at least one of the following: NiCr, NiCrOx, CrOx, and any combination thereof.

5. The glazing according to claim 3, wherein the adhesion layer has a thickness ranging from 1 to 3 nm.

6. The glazing according to claim 1, wherein the total solar transmittance of the glazing is no more than 60%, preferably in the range from 5% to 60%, more preferably in the range from 10% to 40%, and even more preferably from 15% to 25%.

7. The glazing according to claim 1, wherein the at least one area with texturing features of the second glass layer has a haze that ranges from 5 to 99% and the area without the texturing features has a haze of no more than 5%.

8. The glazing according to claim 1, wherein the texturing features are achieved by any one of the following: chemical treatment, sandblasting, laser patterning and embossed roller patterning.

9. The glazing according to claim 1, wherein the texturing features have a size ranging from 1 to 20 μm, and preferably from 2 to 10 μm.

10. The glazing according to claim 1, wherein the at least one area with texturing features has a roughness ranging from 0.01 μm to 1.0 μm, preferably from 0.02 μm to 0.4 μm, and more preferably from 0.05 μm to 0.3 μm.

11. The glazing according to claim 1, wherein the at least one area with texturing features is smaller than the area of the external surface of the second glass layer.

12. The glazing according claim 1, wherein any of the first and/or second glass layers is selected from clear soda-lime glass, tinted soda-lime glass, aluminosilicate glass, borosilicate glass.

13. The glazing according to claim 1, further comprising an infrared blocking layer positioned between the first and second glass layers and selected from the group of a film and/or a coating.

14. The glazing according to claim 1, further comprising a functional element disposed in between the first and second glass layer selected from the following: photovoltaic device, and a variable light transmission element, or a combination thereof.

15. The glazing according to claim 1, further comprising a variable light transmission element with size of less than 70% of the size of the glazing.

16. The glazing according to claim 1, further comprising at least one area with texturing features onto the interior surface of the second glass layer.

17. The glazing according to claim 1, further comprising at least one area with texturing features onto the interior surface of the first glass layer and a color and/or solar control coating disposed onto at least a portion of said at least one area with texturing features.

18. The glazing according to claim 1, further comprising at least one additional layer deposited over the low-emissivity coating, wherein the additional layer comprises an anti-reflective layer, an anti-fingerprint layer or a combination thereof.

19. The glazing according to claim 1 is a roof for a vehicle.

20. A system comprising the laminated glazing of claim 1, and at least one projector, wherein said at least one projector is configured to project an image onto the at least one area with texturing features of the second glass layer.
